(19) United States
(12) Patent Application Publication
(10) Pub. No.: US 2019/0177126 A1
(43) Pub. Date: Jun. 13, 2019

(54) ELEVATOR ROPE SWAY RESTRICTION DEVICE

(71) Applicant: Otis Elevator Company, Farmington, CT (US)

(72) Inventor: Jiro Murata, Oamishirasatoshi (JP)

(21) Appl. No.: 15/834,444

(22) Filed: Dec. 7, 2017

(51) Int. Cl. B66B 7/06; B66B 9/00

(52) U.S. Cl. CPC B66B 7/068; B66B 9/00

(57) ABSTRACT

According to one embodiment, an elevator system is provided which comprises an elevator car vertically movable within a hoistway, a counterweight connected to the elevator car via at least one rope and vertically movable within the hoistway and a rope sway restriction device for restricting the swaying of the at least one rope. The rope sway restriction device includes a rope sway restrictor vertically movable within the hoistway and at least one restrictor rope connecting the rope sway restrictor to the counterweight so that the rope sway restrictor moves vertically within the hoistway in response to movement of the counterweight.

### BACKGROUND

This invention generally relates to elevator systems. More particularly, this invention relates to an elevator rope sway restriction device for restricting the swaying of main ropes.

Many elevator systems include an elevator car and counterweight that are suspended within a hoistway by roping comprising one or more main ropes. Typically, a plurality of ropes, cables or belts are used as the main ropes for supporting the weight of the elevator car and counterweight and for moving the elevator car to desired positions within the hoistway. The main ropes are typically routed about several sheaves according to a desired roping arrangement.

There are conditions where one or more of the main ropes may begin to sway within the hoistway. Rope sway may occur, for example, during earthquakes or very high wind conditions because the building will move responsive to the earthquake or high winds. As the building moves, long ropes associated with the elevator car and counterweight will tend to sway from side to side. This is most prominent in high rise buildings where an amount of building sway is typically larger compared to shorter buildings and when the frequency of the building sway is an integer multiple of the natural frequency of a rope within the hoistway.

Excessive rope sway conditions of the main ropes are undesirable for two main reasons; they can cause damage to the ropes or other equipment in the hoistway and their motion can produce objectionable vibration levels in the elevator car.

Various proposals have been made for mitigating or minimizing sway of main ropes within a hoistway. One example approach includes an elevator rope guide system comprising a plurality of rope guides for restricting the sway of at least one main rope and a plurality of stop mechanisms installed on car guide rails to stop a corresponding rope guide.

While previous approaches have proven useful, those skilled in the art are always striving to make improvements.

### BRIEF SUMMARY

According to one embodiment, an elevator system is provided which comprises an elevator car vertically movable within a hoistway, a counterweight connected to the elevator car via at least one rope and vertically movable within the hoistway and a rope sway restriction device for restricting the swaying of the at least one rope. The rope sway restriction device includes a rope sway restrictor vertically movable within the hoistway and at least one restrictor rope connecting the rope sway restrictor to the counterweight so that the rope sway restrictor moves vertically within the hoistway in response to movement of the counterweight.

In addition to one or more of the features described above, or as an alternative, further embodiments may be included wherein the rope sway restrictor is connected to the counterweight such that the ratio of the travel distance of the rope sway restrictor to the travel distance of the counterweight is about 1:2.

In addition to one or more of the features described above, or as an alternative, further embodiments may be included wherein the rope sway restrictor is positioned at about halfway of the at least one rope in the hoistway on the car side.

In addition to one or more of the features described above, or as an alternative, further embodiments may be included wherein the rope sway restrictor includes a pair of movable pulleys.

In addition to one or more of the features described above, or as an alternative, further embodiments may be included wherein the rope sway restriction device further includes a pair of fixed pulleys positioned in a machine room or an upper portion of the hoistway and the restrictor rope is connected at one end to a dead end hitch in the machine room or the upper portion of the hoistway, extends through the pair of movable pulleys and the pair of fixed pulleys, and is connected to the counterweight at the other end.

In addition to one or more of the features described above, or as an alternative, further embodiments may be included wherein the axes of the fixed pulleys are positioned at an angle of 90 degrees with respect to the axes of the moving pulleys.

In addition to one or more of the features described above, or as an alternative, further embodiments may be included wherein the axes of the fixed pulleys are positioned at an oblique angle with respect to the axes of the moving pulleys.

In addition to one or more of the features described above, or as an alternative, further embodiments may be included wherein the rope sway restrictor includes a rope guide which allows the at least one rope to pass there through and which contacts the at least one rope when an undesired amount of sway of the at least one rope occurs.

In addition to one or more of the features described above, or as an alternative, further embodiments may be included wherein the rope guide includes a box-shaped guide frame and a rubber or plastic material covering the inner surfaces of the guide frame.

In addition to one or more of the features described above, or as an alternative, further embodiments may be included wherein the rope guide includes a box-like support frame rotatably supporting a pair of longitudinal rollers and a pair of lateral rollers.

In addition to one or more of the features described above, or as an alternative, further embodiments may be included wherein the rope sway restrictor is guided along car guide rails.

In addition to one or more of the features described above, or as an alternative, further embodiments may be included wherein the rope sway restrictor includes a guiding mechanism on both ends for guiding the rope sway restrictor along the car guide rails.

In addition to one or more of the features described above, or as an alternative, further embodiments may be included wherein the guiding mechanism is a sliding mechanism.

In addition to one or more of the features described above, or as an alternative, further embodiments may be included wherein the guiding mechanism is a roller mechanism.

According to another embodiment, a rope sway restriction device for restricting the swaying of at least one rope connecting an elevator car and a counterweight of an elevator system is provided. The rope sway restriction device comprises a rope sway restrictor vertically movable within the hoistway and at least one restrictor rope connecting the rope sway restrictor to the counterweight so that the rope sway restrictor moves vertically within the hoistway in response to movement of the counterweight.

In addition to one or more of the features described above, or as an alternative, further embodiments may be included wherein the rope sway restrictor is connected to the counterweight such that the ratio of the travel distance of the rope sway restrictor to the travel distance of the counterweight is about 1:2.

In addition to one or more of the features described above, or as an alternative, further embodiments may be included wherein the rope sway restrictor is positioned at about halfway of the at least one rope in the hoistway on the car side.

In addition to one or more of the features described above, or as an alternative, further embodiments may be included wherein the rope sway restrictor includes a pair of movable pulleys.

In addition to one or more of the features described above, or as an alternative, further embodiments may be included wherein the rope sway restrictor includes a rope guide which allows the at least one rope to pass there through and which contacts the at least one rope when an undesired amount of sway of the at least one rope occurs.

In addition to one or more of the features described above, or as an alternative, further embodiments may be included wherein the rope sway restrictor includes a guiding mechanism on both ends for guiding the rope sway restrictor along car guide rails.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The foregoing and other features, and advantages of the disclosure are apparent from the following detailed description taken in conjunction with the accompanying drawings in which like elements are numbered alike in the several Figs.

FIG. 1 illustrates a schematic view of an elevator system including the elevator rope sway restriction device of the present invention.

FIG. 2 illustrates a top view of a rope sway restrictor of the elevator rope sway restriction device shown in FIG. 1.

FIG. 3 illustrates a perspective view of a further embodiment of a rope guide of the rope sway restrictor shown in FIG. 2.

FIGS. 4A and 4B illustrate exemplary perspective views of a guiding mechanism of the rope sway restrictor shown in FIG. 2.

FIG. 5 is a top plan view showing the arrangement of the sheaves, pulleys and guide rails of the elevator system shown in FIG. 1.

FIG. 6 is a top plan view similar to FIG. 5 of another embodiment of the present invention.

### DETAILED DESCRIPTION

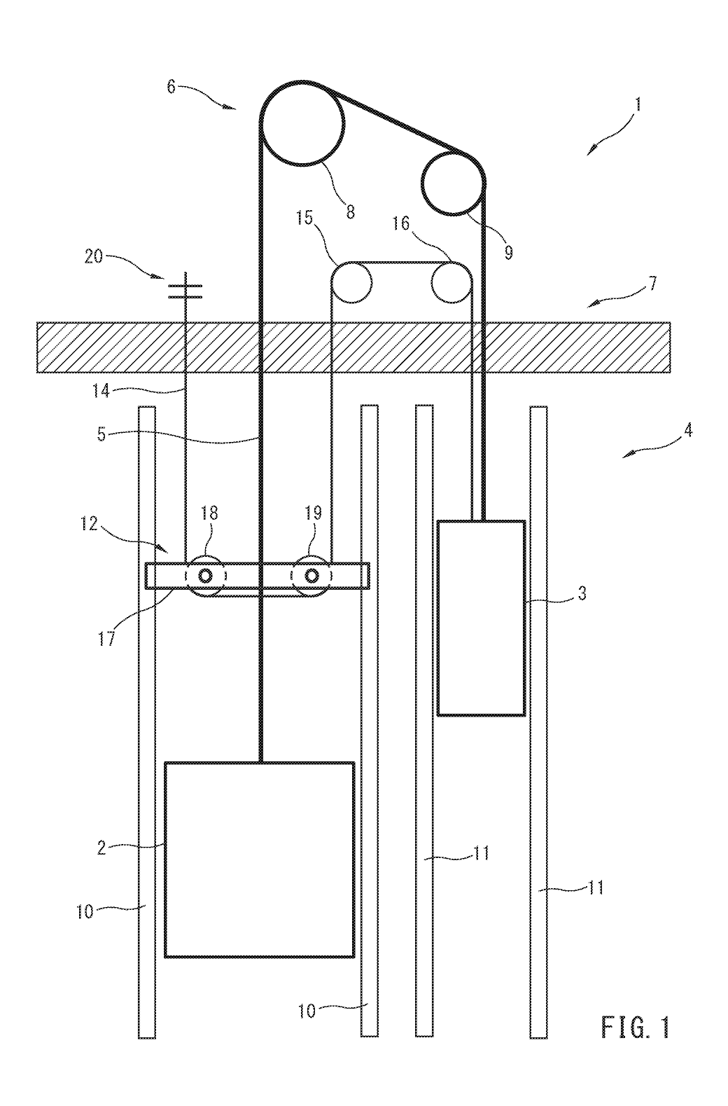

FIG. 1 schematically shows selected portions of an elevator system 1 of the present invention. An elevator car 2 and counterweight 3 are both vertically movable within a hoistway 4. A plurality of main ropes 5 couple the elevator car 2 to the counterweight 3. In this embodiment, the main ropes 5 comprise round steel ropes but the main ropes 5 may comprise belts including a plurality of longitudinally extending wire cords and a coating covering the wire cords. A variety of roping configurations may be useful in an elevator system that includes features designed according to an embodiment of this invention.

The main ropes 5 support the weight of the elevator car 2 and counterweight 3 and propel them in a desired direction within the hoistway 4. An elevator machine 6 is positioned in a machine room 7 or in an upper portion of the hoistway 4 and includes a traction sheave 8 that rotates and causes movement of the main ropes 5 to cause the desired movement of the elevator car 2, for example. The example arrangement includes a deflector sheave 9 to guide movement of the main ropes 5. The illustrated example comprises a single wrap configuration. However, other roping arrangements such as a double wrap configuration are also possible.

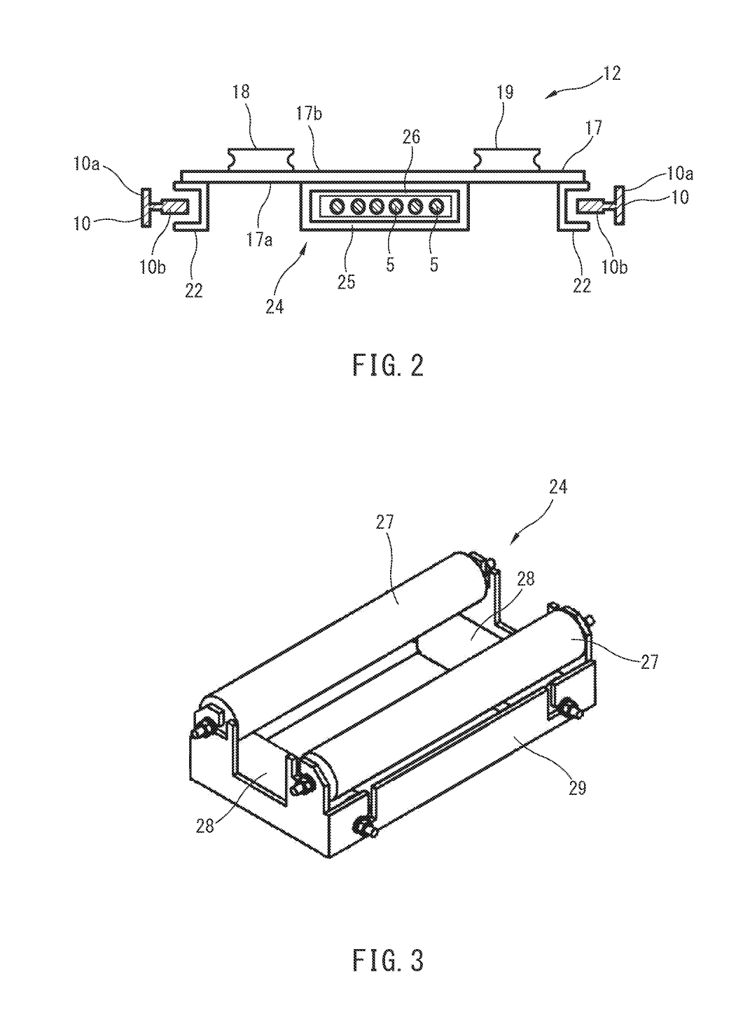

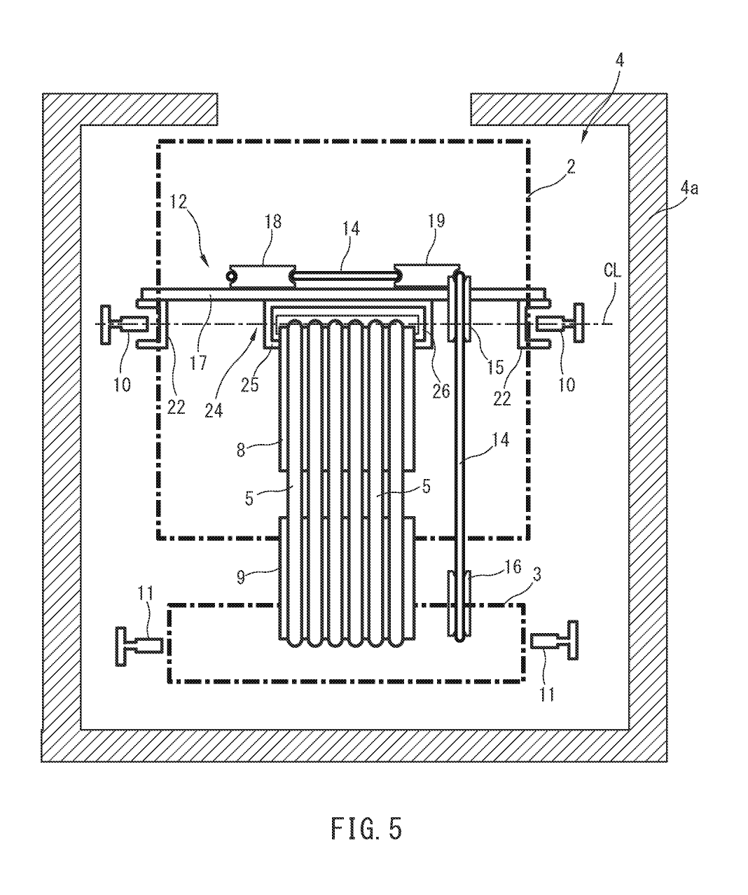

The elevator car 2 is guided along car guide rails 10 respectively installed on a hoistway wall 4a (FIG. 5) on opposite sides of the elevator car 2. The counterweight 3 is guided along counterweight guide rails 11 respectively installed on a hoistway wall 4a on opposite sides of the counterweight 3. The car guide rails 10 and counterweight guide rails 11 have a generally T-shaped cross section such as shown in FIG. 2 with a base portion 10a that is secured to the hoistway wall 5a and a blade portion 10b extending away from the base portion 10a. The blade portion 10b provides guiding surfaces along which guide rollers or slides travel during movement of the elevator car 2 or counterweight 3.

The example elevator system 1 includes a rope sway restriction device for restricting the swaying of the main ropes 5. The rope sway restriction device comprises a rope sway restrictor 12 positioned above the elevator car 2 and vertically movable along the car guide rails 10, at least one restrictor rope 14 connecting the rope sway restrictor 12 to the counterweight 3, and a first fixed pulley 15 and a second fixed pulley 16 which may be positioned in the machine room 7 or an upper portion of the hoistway 4. The rope sway restrictor 12 comprises a rectangular base plate 17 rotatably supporting a first movable pulley 18 and a second movable pulley 19.

The restrictor rope 14 is connected at one end to a dead end hitch 20 which may be positioned in the machine room 7 or an upper portion of the hoistway 4 and extends downward to and around the first movable pulley 18. From here the restrictor rope 14 extends horizontally to and around the second movable pulley 19 and then extends upward to and around the first fixed pulley 15. The restrictor rope 14 further extends horizontally to and around the second fixed pulley 16 and then downward to the counterweight 3 to be connected to the counterweight 3 at the other end. In this embodiment, the restrictor rope 14 is a steel wire rope. However, the restrictor rope 14 may a resin rope. Further, a belt may also be used as the restrictor rope 14.

FIG. 2 shows a top view of the rope sway restrictor 12. The base plate 17 extends laterally between the elevator guide rails 10 and has a first surface 17a facing the car guide rails 10 and a second surface 17b facing away from the car guide rails 10. The first and second movable pulleys 18, 19 are positioned on the second surface 17b of the base plate 17. The first and second movable pulleys 18, 19 may be made of cast iron or cast steel. The movable pulleys 18, 19 may also be made of resins such as nylon for reduction in weight. The rope sway restrictor 12 further comprises a guiding mechanism 22 provided on both lateral ends of the base plate 17 for guiding the rope sway restrictor 12 up and down along the car guide rails 10 and a rope guide 24 fixed to the first side 17a of the base plate 17 for restricting the sway of the main ropes 5.

The rope guide 24 includes a rectangular box-shaped guide frame 25 which has open upper and lower end faces for allowing the main ropes 5 to pass there through and a rubber or plastic material 26 covering the inner surfaces of the guide frame 25 to protect the main ropes 5 from being damaged upon contact with the guide frame 25. The rope guide 24 will not substantially contact the main ropes 5 under normal conditions. However, under conditions where an undesired amount of sway of the main ropes 5 occur, the rope guide 24 will contact the main ropes 5 and restrict the swaying thereof.

In a further embodiment shown in FIG. 3, the rope guide 24 may include a pair of longitudinal rollers 27 and a pair of lateral rollers 28 each rotatably supported on a rectangular box-like support frame 29 which has open upper and lower end faces for allowing the main ropes 5 to pass there through. Under sway conditions, the rollers 27, 28 will roll about their axes responsive to contact with the main ropes 5 and restrict swaying of the main ropes 5.

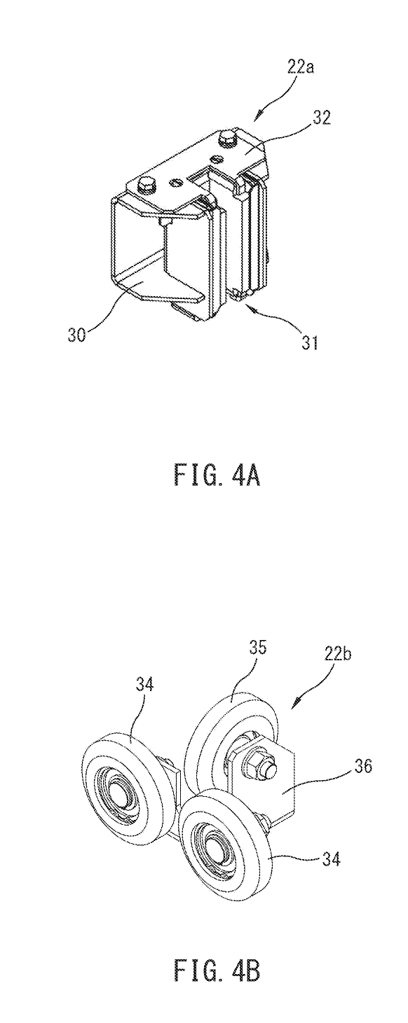

The guiding mechanism 22 may be similar to a conventional guide shoe and may be spring loaded. For example, the guiding mechanism 22 may comprise a sliding mechanism 22a such as shown in FIG. 4A or a roller mechanism 22b such as shown in FIG. 4B. The sliding mechanism 22a includes a housing 30 which receives an insert 31 for slidingly engaging the blade portion 10b of the car guide rail 10, for example. The insert 31 may be retained within the housing 30 by a retaining element 32 bolted to the housing. The roller mechanism 22b includes a pair of rollers 34 each having an axis parallel to the blade portion 10b of the car guide rail 10 and a roller 35 having an axis perpendicular to the blade portion 10b of the car guide rail 10, for example. The rollers 34, 35 are fixed to a bracket 36 and rotatably contact the guiding surfaces of the blade portion 10b.

FIG. 5 is a top plan view of the hoistway 4 showing the arrangement of the traction sheave 8, deflector sheave 9, fixed pulleys 15, 16, rope sway restrictor 12, car guide rails 10, counterweight guide rails 11 and restrictor rope 14. The elevator car 2 and counterweight 3 are shown in phantom. The movable pulleys 18, 19 of the rope sway restrictor 17 are offset from a centerline CL extending through the car guide rails 10 to avoid interference with the main ropes 5. The fixed pulleys 15, 16 are positioned on a lateral side of the sheaves 8, 9 so as not to interfere with the main ropes 5. The axes of the fixed pulleys 15, 16 are at an angle of 90 degrees with respect to the axes of the moving pulleys 18, 19.

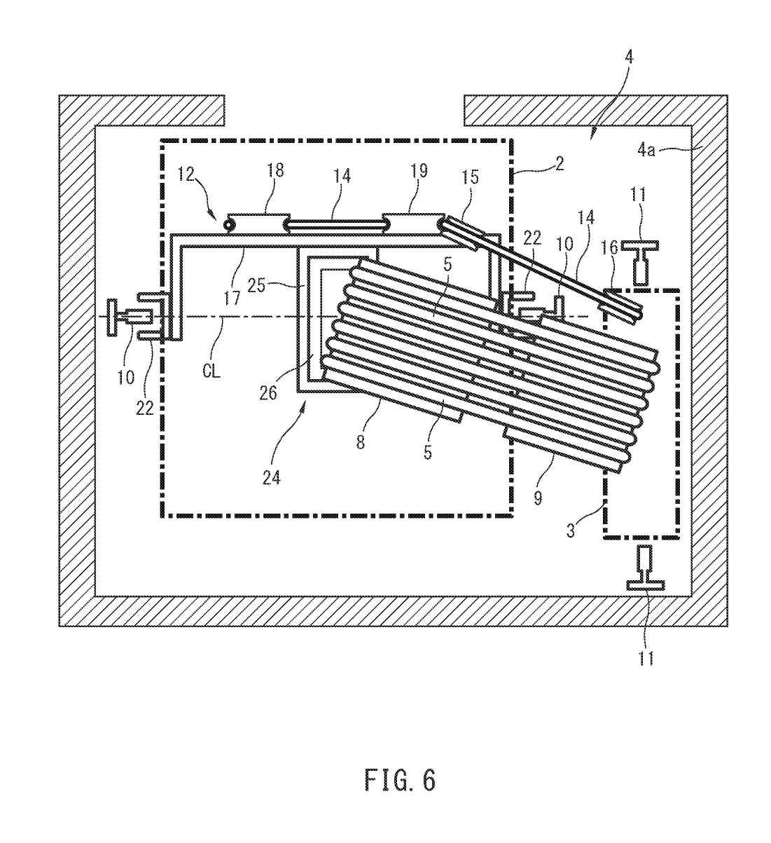

FIG. 6 shows a top plan view similar to FIG. 5 of another embodiment of the present invention. In this embodiment, the counterweight 3 is positioned on a side of the elevator car 2. The axes of the traction sheave 8 and deflector sheave 9 are positioned at an angle with respect to the elevator car 2 and counterweight 3. The base plate 17 of the rope sway restrictor 12 has a U-shaped cross section so as not to interfere with the main ropes 5. The axes of the fixed pulleys 15, 16 are at an oblique angle with respect to the axes of the moving pulleys 18, 19.

Referring again to FIG. 1, as the elevator car 2 travels up and down along the hoistway 4, the counterweight 3 travels along the hoistway 4 in an opposite direction as is conventional. Since the rope sway restrictor 12 is connected to the counterweight 3 via the restrictor rope 14, the rope sway restrictor 12 travels together with the counterweight 3. The direction of travel of the rope sway restrictor 12 is the same as the elevator car 2. In this embodiment, the pulley and restrictor rope roping configuration causes the rope sway restrictor 12 to travel about half the distance of car and counterweight travel. In other words, the ratio of the travel distance of the rope sway restrictor 12 to the travel distance of the car 2 and counterweight 3 is about 1:2. However, other ratios such as 1:3 or 1:4 are also possible. A variety of pulley and restrictor rope roping configurations may be used to achieve such ratios.

Accordingly, the rope sway restrictor 12 will always be positioned at about halfway of the main ropes 5 in the hoistway 4 on the car side and limit rope sway of the main ropes 5 at this position which is effective to restrict rope sway. When the elevator car 2 reaches its uppermost position in the hoistway 4, the rope sway restrictor 12 will be positioned between the elevator car 2 and the ceiling of the hoistway 4. The rope sway restrictor 12 will not in any case contact the elevator car 2 or the hoistway ceiling.

The present invention provides an elevator rope sway restriction device which does not require the installation of stop mechanisms on car guide rails to stop a rope guide. Additionally, since the rope sway restrictor 12 of the present invention is moved up and down along the hoistway 4 by the counterweight 3, no sensors, actuators or electronic devices are required and a simple and effective device for restricting rope sway may be provided.

The terminology used herein is for the purpose of describing particular embodiments only and is not intended to be limiting. While the description has been presented for purposes of illustration and description, it is not intended to be exhaustive or limited to embodiments in the form disclosed. Many modifications, variations, alterations, substitutions or equivalent arrangement not hereto described will be apparent to those of ordinary skill in the art without departing from the scope of the disclosure. Additionally, while the various embodiments have been described, it is to be understood that aspects may include only some of the described embodiments. Accordingly, the disclosure is not to be seen as limited by the foregoing description, but is only limited by the scope of the appended claims.

What is claimed is:

1. An elevator system, comprising:
an elevator car vertically movable within a hoistway;
a counterweight connected to the elevator car via at least one rope and vertically movable within the hoistway; and
a rope sway restriction device for restricting the swaying of the at least one rope, the rope sway restriction device including:
a rope sway restrictor vertically movable within the hoistway; and
at least one restrictor rope connecting the rope sway restrictor to the counterweight so that the rope sway restrictor moves vertically within the hoistway in response to movement of the counterweight.

2. The elevator system of claim 1, wherein the rope sway restrictor is connected to the counterweight such that the ratio of the travel distance of the rope sway restrictor to the travel distance of the counterweight is about 1:2.

3. The elevator system of claim 1, wherein the rope sway restrictor is positioned at about halfway of the at least one rope in the hoistway on the car side.

4. The elevator system of claim 1, wherein the rope sway restrictor includes a pair of movable pulleys.

5. The elevator system of claim 4, wherein the rope sway restriction device further includes a pair of fixed pulleys positioned in a machine room or an upper portion of the hoistway and the restrictor rope is connected at one end to a dead end hitch in the machine room or the upper portion of the hoistway, extends through the pair of movable pulleys and the pair of fixed pulleys, and is connected to the counterweight at the other end.

6. The elevator system of claim 5, wherein the axes of the fixed pulleys are positioned at an angle of 90 degrees with respect to the axes of the moving pulleys.

7. The elevator system of claim 5, wherein the axes of the fixed pulleys are positioned at an oblique angle with respect to the axes of the moving pulleys.

8. The elevator system of claim 1, wherein the rope sway restrictor includes a rope guide which allows the at least one rope to pass there through and which contacts the at least one rope when an undesired amount of sway of the at least one rope occurs.

9. The elevator system of claim 8, wherein the rope guide includes a box-shaped guide frame and a rubber or plastic material covering the inner surfaces of the guide frame.

10. The elevator system of claim 8, wherein the rope guide includes a box-like support frame rotatably supporting a pair of longitudinal rollers and a pair of lateral rollers.

11. The elevator system of claim 1, wherein the rope sway restrictor is guided along car guide rails.

12. The elevator system of claim 11, wherein the rope sway restrictor includes a guiding mechanism on both ends for guiding the rope sway restrictor along the car guide rails.

13. The elevator system of claim 12, wherein the guiding mechanism is a sliding mechanism.

14. The elevator system of claim 12, wherein the guiding mechanism is a roller mechanism.

15. A rope sway restriction device for restricting the swaying of at least one rope connecting an elevator car and a counterweight of an elevator system, the rope sway restriction device, comprising:
a rope sway restrictor vertically movable within the hoistway; and
at least one restrictor rope connecting the rope sway restrictor to the counterweight so that the rope sway restrictor moves vertically within the hoistway in response to movement of the counterweight.

16. The rope sway restriction device of claim 15, wherein the rope sway restrictor is connected to the counterweight such that the ratio of the travel distance of the rope sway restrictor to the travel distance of the counterweight is about 1:2.

17. The rope sway restriction device of claim 15, wherein the rope sway restrictor is positioned at about halfway of the at least one rope in the hoistway on the car side.

18. The rope sway restriction device of claim 15, wherein the rope sway restrictor includes a pair of movable pulleys.

19. The rope sway restriction device of claim 15, wherein the rope sway restrictor includes a rope guide which allows the at least one rope to pass there through and which contacts the at least one rope when an undesired amount of sway of the at least one rope occurs.

20. The rope sway restriction device of claim 15, wherein the rope sway restrictor includes a guiding mechanism on both ends for guiding the rope sway restrictor along car guide rails.
